(19) United States
(12) Patent Application Publication
(10) Pub. No.: US 2020/0094519 A1
(43) Pub. Date: Mar. 26, 2020

(54) IMPACT-RESISTANT COMPOSITE STRUCTURE

(71) Applicant: Chun-Chung LIU, Taichung City (TW)

(72) Inventor: Chun-Chung LIU, Taichung City (TW)

(21) Appl. No.: 16/543,821

(22) Filed: Aug. 19, 2019

(30) Foreign Application Priority Data
Sep. 21, 2018 (TW) 107133371

(51) Int. Cl. B32B 5/26; B32B 5/02; B32B 7/12

(52) U.S. Cl. CPC B32B 5/26; B32B 5/022; B32B 7/12; B32B 5/024; B32B 2262/0284; B32B 2307/558; B32B 2262/101; B32B 2262/106; B32B 2260/021; B32B 2260/046; B32B 2262/0253

(57) ABSTRACT

An impact-resistant composite structure includes a first fabric, a second fabric layer, a non-woven fabric, a fiber resin layer and a polymer adhesive. Wherein the first fabric includes an outer texture surface and an inner texture surface opposite to each other and a thickness between them is not less than 2.0 mm. The second fabric layer includes a front texture surface and a rear texture surface and a fiber tensile strength of them is not less than 10 g/d. The non-woven fabric is disposed between the inner texture surface of the first fabric and the front texture surface of the second fabric layer. The fiber resin layer have a roughened surface adhered to the rear texture surface of the second fabric layer. The polymer adhesive bonds the first fabric, the non-woven fabric, the second fabric layer and the fiber resin layer.

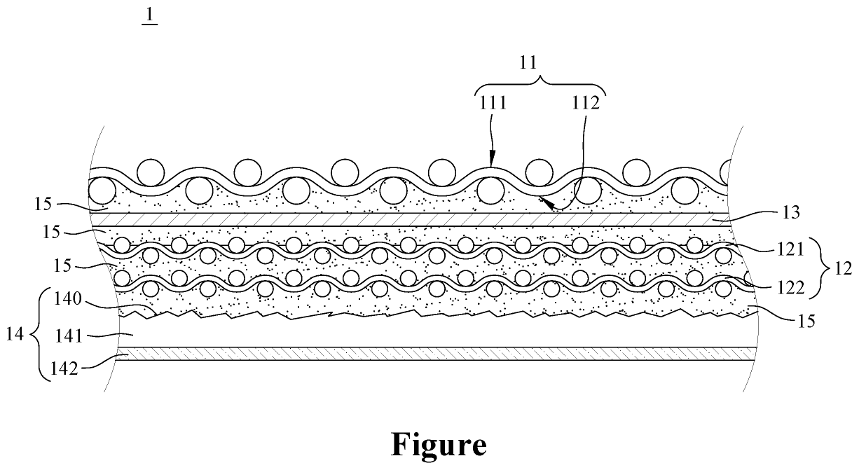

### CROSS-REFERENCE TO RELATED APPLICATION

This application claims the priority of Taiwanese patent application No. 107133371, filed on Sep. 21, 2018, which is incorporated herewith by reference.

### BACKGROUND OF THE INVENTION

### 1. Field of the Invention

The present invention relates to a protective structure, and particularly, to an impact-resistant composite structure having the effect of anti-puncture, bullet proof and explosion proof

### 2. The Prior Arts

With the development of the economy, the risks of traffic accidents, knife robbery, and school shootings that endanger personal safety also occur frequently. Therefore, the demand for protective articles with anti-puncture and bullet proof functions is gradually increasing. The existing protective articles are composed of multiple layers of high-strength fabrics, ceramic or metal materials, and adhesive resins, wherein aromatic polyamide fibers and ultra-high molecular weight polyethylene fibers are mainly used as the high-strength fabrics.

The aromatic polyamide fiber has a density of 1.45 g/cm³ and properties of high tensile strength and high elastic modulus but has poor resistance to strong acid, strong alkali, ultraviolet light and friction. The ultra-high molecular weight polyethylene fiber has a molecular weight of 2 to 6 million and a fiber density of 0.96 g/cm³, which has higher tensile strength, lower elongation and lighter weight than aromatic polyamide fibers and has good resistance to chemicals, temperatures, humidity and ultraviolet light. At present, most protective articles are manufactured by high-strength fabric made of ultra-high molecular weight polyethylene fibers.

However, due to the chemical properties of high hydrophobicity and low surface activity of the ultra-high polyethylene fibers, the fiber surface is very smooth and its friction coefficient is low. Therefore, the cohesion among the fibers is low, and the problem of poor interface bonding easily occurs when the ultra-high polyethylene fibers are stacked with other materials to manufacture protective articles. It not only affects the process yield and product cost but also detracts from the performance of anti-puncture, bullet proof, explosion proof, and durability of protective articles. Therefore, how to solve the problems of processing, yield and durability of the existing high-strength fiber fabrics and improve the performance of the protective articles is the main objective of developing the present invention.

### SUMMARY OF THE INVENTION

In order to achieve the above objectives, the present invention provides an impact-resistant composite structure, which includes a first fabric, a second fabric layer, a non-woven fabric, a fiber resin layer and a polymer adhesive. Wherein the first fabric includes an outer texture surface and an inner texture surface opposite to each other and a thickness between them is not less than 2.0 mm. The second fabric layer includes a front texture surface and a rear texture surface and a fiber tensile strength of them is not less than 10 g/d. The non-woven fabric is disposed between the inner texture surface of the first fabric and the front texture surface of the second fabric layer. The fiber resin layer have a roughened surface adhered to the rear texture surface of the second fabric layer. The polymer adhesive bonds the first fabric, the non-woven fabric, the second fabric layer and the fiber resin layer.

According to an embodiment, the outer texture surface of the first fabric includes a plurality of weft float stripes, wherein the height difference of each of the weft float stripes is not less than 0.2 mm×0.2 mm, and the distance of adjacent two weft float stripes is not larger than 12 mm.

According to an embodiment, the material of the first fabric is polyethylene terephthalate fiber.

According to an embodiment, the second fabric layer includes a plurality of second fabrics stacked with each other; wherein the two second fabrics located on both sides of the second fabric layer form the front texture surface and the rear texture surface, respectively.

According to an embodiment, the material of the second fabrics is polyethylene terephthalate fiber.

According to an embodiment, the impact-resistant composite structure further includes a plurality of the non-woven fabrics disposed between the inner texture surface of the first fabric and the front texture surface of the second fabric layer, and disposed between the rear texture surface of the second fabric layer and the front texture surface of another second fabric layer, respectively.

According to an embodiment, the material of the non-woven fabric is polypropylene fiber.

According to an embodiment, the roughness of the roughened surface of the fiber resin layer is not less than 0.05 mm.

According to an embodiment, the fiber resin layer includes a third fabric and a curable resin.

According to an embodiment, the material of the third fabric is glass fiber or carbon fiber, and the material of the curable resin is silica gel.

The impact-resistant composite structure of the present invention includes the first fabric, the non-woven fabric and the second fabric layer, which have high tensile strength, the fiber resin layer, which has the roughened surface, and the polymer adhesive. The non-woven fabric and the roughened surface of the fiber resin layer can enhance strength, fastness and durability of the bonding interface between different fabrics, thereby effectively improving the performance of anti-puncture, bullet proof and explosion proof of the impact-resistant composite structure. Furthermore, since the impact-resistant composite structure of the present invention is light in weight, thin in thickness and easy to be processed, it is possible to cut the impact-resistant composite structure into any desired shape and size of various protective articles such as bullet proof cloth, bullet proof backpack, bullet proof helmet and bullet proof pad by present laser or other cutting equipment, thereby greatly reducing the production cost of protective articles.

### BRIEF DESCRIPTION OF THE DRAWINGS

The present invention will be apparent to those skilled in the art by reading the following detailed description of a preferred embodiment thereof, with reference to the attached drawing, in which:

FIGURE illustrates a cross-sectional view of the impact-resistant composite structure of the present invention.

### DETAILED DESCRIPTION OF THE PREFERRED EMBODIMENT

The accompanying drawing is included to provide a further understanding of the invention, and is incorporated in and constitutes a part of this specification. The drawing illustrates embodiments of the invention and, together with the description, serves to explain the principles of the invention.

The embodiments of the present invention will be described in more detail with reference to the drawings and the reference numerals, such that the present invention can be implemented by those skilled in the art after studying this specification. It should be noted that, in order to clearly illustrate the main features of the present invention, the figure only shows the relative relationship or operation mode between the main elements in a schematic manner but not be drawn according to the actual size. Therefore, the thickness, size, shape, arrangement, configuration, and the like of the main elements in the figure are for reference only and are not intended to limit the scope of the present invention.

FIGURE illustrates a cross-sectional view of an impact-resistant composite structure of the present invention. As shown in the figure, the impact-resistant composite structure 1 includes a first fabric 11, a second fabric layer 12, a non-woven fabric 13, a fiber resin layer 14 and a polymer adhesive 15. The first fabric 11 includes an outer texture surface 111 and an inner texture surface 112 opposite to each other, and a thickness between the outer texture surface 111 and the inner texture surface 112 is not less than 2.0 mm. The second fabric layer 12 includes a front texture surface 121 and a rear texture surface 122, and the fiber tensile strength of the front texture surface 121 and the rear texture surface 122 is not less than 10 g/d. The non-woven fabric 13 is disposed between the inner texture surface 112 of the first fabric 11 and the front texture surface 121 of the second fabric layer 12. The fiber resin layer 14 have a roughened surface 40 adhered to the rear texture surface 122 of the second fabric layer 12. The polymer adhesive 15 bonds the first fabric 11, the non-woven fabric 13, the second fabric layer 12 and the fiber resin layer 14.

The first fabric 11 is the first layer of protective structure when resisting high speed impact of knives, bullets, artillery shell fragments and the like. Thus, fibers with high tensile strength and high elastic modulus can be chosen to weave woven fabric with high density and high thickness by loom. Wherein the warp and weft texture toward outer environment is the outer texture surface 111, and the warp and weft texture, adhered to impact-resistant materials such as the non-woven fabric 13, the second fabric layer 12, and the like, is the inner texture surface 112.

In one embodiment, polyethylene terephthalate (PET) fiber with high tensile strength first fabric is chosen as the first fabric, in which: the denier number (D) of the warp and weft yarns is not less than 1200 D (for example but not limited to 1680 D); the weaving is conducted with a loom by regulating the fabric width to the maximum width; the warp yarn density is not less than 25 filaments/inch and the weft yarn density is not less than 19 filaments/inch; and the thickness between the outer texture surface 111 and the inner texture surface 112 is, for example, 2.0, 2.5 or 3.0 mm. Since concave-convex fabric texture can disperse the impact force of knives and bullets and enhance the damage resistance of the fabrics, a plurality of weft float stripes (transversal stripes) can form at the outer texture surface 111 of the first fabric 11 by arranging multiple filaments or thick weft yarn at intervals, in which: the height difference of each of the weft float stripes is not less than 0.2 mm×0.2 mm; and the distance of adjacent two weft float stripes is not larger than 12 mm, for example but not limited to, 2, 4, 6, 8, 10 or 12.

The second fabric layer 12 and the non-woven fabric 13 are the structure for resisting high speed impact of knives, bullets, artillery shell fragments and the like. The second fabric layer 12 includes a plurality of second fabrics stacked with each other. In the second fabrics located at both sides, the second fabric, which first contacts the impact force, forms the front texture surface 121; and the second fabric, which last contacts the impact force, forms the rear texture surface 122. Fibers with high tensile strength and high elastic modulus can be chosen as each second fabric. The non-woven fabric 13 is manufactured mainly by high-temperature melting, spinning, paving, and hot-pressing and curling and has strong toughness and flexibility.

In one embodiment, the second fabric layer 12 includes two second fabrics stacked with each other, in which: each of the second fabrics is PET woven fabric; the denier number of the warp and weft yarns is not less than 300 D (for example but not limited to 420 D); the weight/yard of each second fabric is not larger than that of the first fabric 11; the two second fabrics, located at the front texture surface 121 and the rear texture surface 122 respectively, are stacked with each other in a manner that the arranging directions of the warp yarns of them are different, for example, the warp yarns of the front texture surface 121 and the rear texture surface 122 are arranged at an angle of 15°, 30°, 45°, 60°, 75° or 90°; and polypropylene fiber is chosen as the material of the non-woven fabric 13.

In another embodiment, the non-woven fabric 13 can be disposed not only between the inner texture surface 112 of the first fabric 11 and the front texture surface 121 of the second fabric layer 12 but also between the rear texture surface 122 of a second fabric layer 12 and the front texture surface 121 of another second fabric layer 12. That is, a plurality of non-woven fabric 13-second fabric layer 12 combinations can be disposed between the first fabric 11 and the fiber resin layer 14, for example, it can be disposed as first fabric 11-non-woven fabric 13-second fabric layer 12-non-woven fabric 13-second fabric layer 12-fiber resin layer 14, to further enhancing the performance of the impact-resistant composite structure 1.

The fiber resin layer 14, which is the structure for preventing penetration of knives, bullets, artillery shell fragments and the like, includes a third fabric 141 and a curable resin 142. Fibers with high tensile strength, high-temperature tolerance, and high shock absorption can be chosen as the third fabric 141. Resin with high-temperature tolerance, high shock absorption, water proof property, excellent stability can be chosen as the curable resin 142.

In one embodiment, glass fiber cloth, which contains silicon dioxide, aluminum oxide, calcium oxide, sodium oxide or boron oxide, or carbon fiber cloth can be chosen as the third fabric 141; silica gel having high affinity with glass fiber can be chosen as the curable resin 142 to manufacture the fiber resin layer 14; and epoxy resin can be chosen as the polymer adhesive 15.

It should be emphasized that, since high strength fibers have chemical properties of high hydrophobicity and low surface activity, even with high-adhesive adhesives, the tightness and the fastness of bonding interface between 2 different types of high strength fibers still do not sufficiently achieve the effect of preventing knife-puncture or gun-shooting. However, in the present invention, since the contact surface area and the friction resistance of the bonding interfaces among the first fabric 11, the second fabric layer 12 and the fiber resin layer 14 are enhanced by the non-woven fabric 13 and the roughened surface 140 of the fiber resin layer 14, it is possible for the strength and the fastness of the bonding interface of the impact-resistant composite structure 1 to be sufficient to achieve the requirements of anti-puncture, bullet proof and explosion proof materials.

The manufacturing method of the impact-resistant composite structure of the present invention will be described by the following specific examples. First, coat the glass fiber cloth (TAIWAN GLASS IND. CORP., Direct Roving 346, 2300±230 tex) with liquid silica gel on both sides, then pressurize at 2˜150° C. of temperature for 0.5˜3 hour by coating machine and dry for 72 hours or above, and then roughen the surface of the glass fiber cloth-silica gel composite structure with a 1000-mesh silicon carbide sand cloth. Next, coat the roughened surface of the glass fiber cloth-silica gel composite structure and the surface of the high-strength PET cloth (the woven fabric of 420D warp and 420D weft) with liquid epoxy resin, then pressured-bond the PET cloth and the glass fiber cloth-silica gel composite structure at 50 to 120° C. of temperature and 50 to 70 revolution/hour of rotation speed with multi-roller laminator and then dry for 48 hours or above; then, coat the surfaces of another high-strength PET cloth (the woven fabric of 420 D warp and 420 D weft) and the PET cloth-glass fiber cloth-silica gel composite structure with liquid epoxy resin, then pressured-bond the PET cloth and the PET cloth-glass fiber cloth-silica gel composite structure at 50 to 120° C. of temperature and 50 to 70 revolution/hour of rotation speed with multi-roller laminator and then dry for 48 hours or above. Next, coat the surfaces of the PP non-woven fabric and the PET cloth-PET cloth-glass fiber cloth-silica gel composite structure with liquid epoxy resin, then pressured-bond the PP non-woven fabric and the PET cloth-PET cloth-glass fiber cloth-silica gel composite structure at 50 to 120° C. of temperature and 50 to 70 revolution/hour of rotation speed with multi-roller laminator and then dry for 48 hours or above. Finally, coat the surfaces of the shell fabric grade PET cloth (the woven fabric of 1680 D warp and 1680 D weft) and the PP non-woven fabric-PET cloth-PET cloth-glass fiber cloth-silica gel composite structure with liquid epoxy resin, then pressured-bond the shell fabric grade PET cloth and the PP non-woven fabric-PET cloth-PET cloth-glass fiber cloth-silica gel composite structure at 70 to 150° C. of temperature and 30 to 50 revolution/hour of rotation speed with double-roller flatbed laminator and then dry for 72 hours or above; then the impact-resistant composite structure of the present invention is completed.

The impact-resistant composite structure 1 can be manufactured by roll-to-roll method, and then cut to the desired size of the protective articles. If glass fiber cloth is used as the material of the fiber resin layer, glass fiber burrs will occurs after cutting the impact-resistant composite structure 1 containing the glass fiber cloth, which will affect the subsequent processing and use. Therefore, after being cut, the impact-resistant composite structure 1 can be treated with paint edge treatment.

The impact-resistant composite structure of the present invention was tested according to European Union anti-puncture test standard EN 12568:2010, 6.2.1 & 6.4: Nail Penetration Resistance after Thermal Ageing Test of Non-Metal Penetration Resistant Inserts; the test results show that the impact-resistant composite structure of the present invention can be resistant to 3300 N/m² of impact force. The impact-resistant composite structure of the present invention is shot with 9 mm bullets, and V50 (the initial velocity of the bullets when 50% of the bullets are intercepted and 50% of the bullets fully penetrates) was measured; the test result showed that the impact-resistant composite structure of the present invention can achieve 500 m/sec or above of V50. It can be seen from various impact test results that the impact-resistant composite structure manufactured by combining the various fibers and resin materials has strong protective performance and can effectively resist the impact force of knives, bullets and artillery shell fragments.

The impact-resistant composite structure of the present invention includes the first fabric, the non-woven fabric and the second fabric layer, which have high tensile strength, the fiber resin layer, which has the roughened surface, and the polymer adhesive. The non-woven fabric and the roughened surface of the fiber resin layer can enhance strength, fastness and durability of the bonding interface between different fabrics, thereby effectively improving the performance of anti-puncture, bullet proof and explosion proof of the impact-resistant composite structure. Furthermore, since the impact-resistant composite structure of the present invention is light in weight, thin in thickness and easy to be processed, it is possible to cut the impact-resistant composite structure into any desired shape and size of various protective articles such as bullet proof cloth, bullet proof backpack, bullet proof helmet and bullet proof pad by present laser or other cutting equipment, thereby greatly reducing the production cost of protective articles.

The above-mentioned embodiments are merely for illustrating the principles and effects of the present invention but not intended to limit the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An impact-resistant composite structure comprising:
a first fabric including an outer texture surface and an inner texture surface which are opposite to each other, wherein a thickness between the outer texture surface and the inner texture surface is not less than 2.0 mm;
a second fabric layer including a front texture surface and a rear texture surface, wherein a fiber tensile strength of the front texture surface and the rear texture surface is not less than 10 g/d;
at least one non-woven fabric disposed between the inner texture surface of the first fabric and the front texture surface of the second fabric layer;
a fiber resin layer having a roughened surface adhered to the rear texture surface of the second fabric layer; and
a polymer adhesive which bonds the first fabric, the non-woven fabric, the second fabric layer and the fiber resin layer.

2. The impact-resistant composite structure according to claim 1, wherein the outer texture surface of the first fabric includes a plurality of weft float stripes, a height difference of each of the weft float stripes is not less than 0.2 mm×0.2 mm, and a distance of adjacent two weft float stripes is not larger than 12 mm.

3. The impact-resistant composite structure according to claim 1, wherein a material of the first fabric is polyethylene terephthalate fiber.

4. The impact-resistant composite structure according to claim 1, wherein the second fabric layer includes a plurality of second fabrics stacked with each other, and the two second fabrics located on both sides of the second fabric layer form the front texture surface and the rear texture surface, respectively.

5. The impact-resistant composite structure according to claim 4, wherein a material of the second fabrics is polyethylene terephthalate fiber.

6. The impact-resistant composite structure according to claim 1, further comprising a plurality of the non-woven fabrics disposed between the inner texture surface of the first fabric and the front texture surface of the second fabric layer, and disposed between the rear texture surface of the second fabric layer and the front texture surface of another second fabric layer, respectively.

7. The impact-resistant composite structure according to claim 1, wherein a material of the non-woven fabric is polypropylene fiber.

8. The impact-resistant composite structure according to claim 1, wherein a roughness of the roughened surface of the fiber resin layer is not less than 0.05 mm.

9. The impact-resistant composite structure according to claim 1, wherein the fiber resin layer includes a third fabric and a curable resin.

10. The impact-resistant composite structure according to claim 9, wherein a material of the third fabric is glass fiber or carbon fiber, and a material of the curable resin is silica gel.
